(19) United States
(12) Patent Application Publication
(10) Pub. No.: US 2026/0119964 A1
(43) Pub. Date: Apr. 30, 2026

(54) SYSTEMS, APPARATUSES, METHODS, AND COMPUTER PROGRAM PRODUCTS FOR MODEL DEPLOYMENT

(71) Applicant: Honeywell International Inc., Charlotte, NC (US)

(72) Inventors: Bhabesh Chandra Acharya, Bangalore (IN); Kumaresh Baabu, Bangalore (IN); Manjunath Reddy S, Bangalore (IN); Sudip Pradhan, Bangalore (IN); Ashutosh Kotni, Bangalore (IN)

(21) Appl. No.: 18/925,327

(22) Filed: Oct. 24, 2024

(51) Int. Cl. G06N 20/00

(52) U.S. Cl. CPC G06N 20/00

(57) ABSTRACT

A method herein includes receiving machine learning code from a provisioning device. In some embodiments, the method includes generating a generated machine learning artifact by performing a machine learning training operation using the machine learning code. In some embodiments, the method includes generating a first machine learning image by performing a first build operation using the generated machine learning artifact. In some embodiments, the method includes deploying the first machine learning image to a first application. In some embodiments, the method includes establishing a first inferencing interface of between the first application and an endpoint. In some embodiments, the method includes causing the first application to generate a first inferencing processing response by applying a first inferencing processing request to the first machine learning image. In some embodiments, the method includes causing the first application to provide the first inferencing processing response to the endpoint via the first inferencing interface.

### TECHNOLOGICAL FIELD

Embodiments of the present disclosure relate generally to systems, apparatuses, methods, and computer program products for model deployment.

### TECHNOLOGICAL FIELD

Applicant has identified many technical challenges and difficulties associated with systems, apparatuses, methods, and computer program products for model deployment. Through applied effort, ingenuity, and innovation, Applicant has solved problems related to systems, apparatuses, methods, and computer program products for model deployment by developing solutions embodied in the present disclosure, which are described in detail below.

### BRIEF SUMMARY

Various embodiments described herein relate to systems, apparatuses, methods, and computer program products for model deployment.

In accordance with one aspect of the disclosure a method is provided. In some embodiments, the method includes receiving machine learning code from a provisioning device. In some embodiments, the method includes generating a generated machine learning artifact by performing a machine learning training operation using the machine learning code. In some embodiments, the method includes generating a first machine learning image by performing a first build operation using the generated machine learning artifact. In some embodiments, the method includes deploying the first machine learning image to a first application. In some embodiments, the method includes establishing a first inferencing interface of between the first application and an endpoint. In some embodiments, the method includes causing the first application to generate a first inferencing processing response by applying a first inferencing processing request to the first machine learning image. In some embodiments, the method includes causing the first application to provide the first inferencing processing response to the endpoint via the first inferencing interface.

In some embodiments, the method includes deploying the generated machine learning artifact to a cloud-native application.

In some embodiments, the method includes establishing a cloud-native application inferencing interface between the cloud-native application and the endpoint.

In some embodiments, the method includes causing the cloud-native application to generate a second inferencing processing response by applying a second inferencing processing request to the generated machine learning artifact.

In some embodiments, the method includes causing the cloud-native application to provide the second inferencing processing response to the endpoint via the cloud-native application inferencing interface.

In some embodiments, the method includes receiving a received machine learning artifact from the provisioning device.

In some embodiments, the method includes deploying the received machine learning artifact to a cloud-native application.

In some embodiments, the method includes establishing a cloud-native application inferencing interface between the cloud-native application and the endpoint.

In some embodiments, the method includes causing the cloud-native application to generate a third inferencing processing response by applying a third inferencing processing request to the received machine learning artifact.

In some embodiments, the method includes causing the cloud-native application to provide the third inferencing processing response to the endpoint via the cloud-native application inferencing interface.

In some embodiments, the method includes receiving a received machine learning artifact from the provisioning device.

In some embodiments, the method includes generating a second machine learning image by performing a second build operation using the received machine learning artifact.

In some embodiments, the method includes deploying the second machine learning image to the first application.

In some embodiments, the method includes causing the first application to generate a fourth inferencing processing response by applying a fourth inferencing processing request to the received machine learning artifact.

In some embodiments, the method includes causing the first application to provide the fourth inferencing processing response to the endpoint via the first inferencing interface.

In some embodiments, the first application comprises a container-based application or an edge-based application.

In some embodiments, the first inferencing interface comprises a container-based application inferencing interface or an edge-based application inferencing interface.

In some embodiments, the method includes storing the generated machine learning artifact in an artifact repository.

In some embodiments, the method includes storing the first machine learning image in one of one or more image repositories.

In some embodiments, the method includes performing a software composition operation on the machine learning code.

In some embodiments, the first inferencing processing request comprises an unprocessed image and the first inferencing processing response comprises a processed image.

In some embodiments, the method includes generating a model deployment operations interface component.

In some embodiments, the model deployment operations interface component comprises a model deployment display element and a software composition display element.

In some embodiments, the method includes causing the model deployment operations interface component to be rendered to a model deployment operations interface.

In accordance with another aspect of the disclosure, an apparatus is provided. In some embodiments, the apparatus includes memory and one or more processors communicatively coupled to the memory. In some embodiments, the one or more processors are configured to generate a generated machine learning artifact by performing a machine learning training operation using the machine learning code. In some embodiments, the one or more processors are configured to generate a first machine learning image by performing a first build operation using the generated machine learning artifact. In some embodiments, the one or more processors are configured to deploy the first machine learning image to a first application. In some embodiments, the one or more processors are configured to establish a first inferencing interface of between the first application and an endpoint. In some embodiments, the one or more processors are configured to cause the first application to generate a first inferencing processing response by apply a first inferencing processing request to the first machine learning image. In some embodiments, the one or more processors are configured to cause the first application to provide the first inferencing processing response to the endpoint via the first inferencing interface.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for generating a generated machine learning artifact by performing a machine learning training operation using the machine learning code. In some embodiments, the computer program code, in execution with at least one processor, configures the computer program product for generating a first machine learning image by performing a first build operation using the generated machine learning artifact. In some embodiments, the computer program code, in execution with at least one processor, configures the computer program product for deploying the first machine learning image to a first application. In some embodiments, the computer program code, in execution with at least one processor, configures the computer program product for establishing a first inferencing interface of between the first application and an endpoint. In some embodiments, the computer program code, in execution with at least one processor, configures the computer program product for causing the first application to generate a first inferencing processing response by applying a first inferencing processing request to the first machine learning image. In some embodiments, the computer program code, in execution with at least one processor, configures the computer program product for causing the first application to provide the first inferencing processing response to the endpoint via the first inferencing interface.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an interface in accordance with one or more embodiments of the present disclosure;

FIG. 4 illustrates a flowchart of an example method in accordance with one or more embodiments of the present disclosure;

FIG. 5 illustrates a flowchart of an example method in accordance with one or more embodiments of the present disclosure;

FIG. 6 illustrates a flowchart of an example method in accordance with one or more embodiments of the present disclosure;

FIG. 7 illustrates a flowchart of an example method in accordance with one or more embodiments of the present disclosure; and

FIG. 8 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein include systems, apparatuses, methods, and computer program products for model deployment. As would be understood by one skilled in the field to which this disclosure pertains, there are numerous example scenarios in which systems, apparatuses, methods, and computer program products for model deployment are desirable.

In many applications, it may be desirable to use systems, apparatuses, methods, and computer program products for model deployment. In some implementations, it may be desirable to use systems, apparatuses, methods, and computer program products for model deployment in order to seamlessly deploy models, such as machine learning related models, to a variety of different applications. In some implementations, it may be desirable to use systems, apparatuses, methods, and computer program products for model deployment in order to control models, such as machine learning related models, that are deployed to a variety of different applications. For example, it may be desirable to deploy models to one or more of a cloud-native application, a container-based application, and/or an edge-based application and/or control models deployed at one or more of a cloud-native application, a container-based application, and/or an edge-based application.

Example solutions for deploying models include using computing devices and/or repositories to deploy the models. However, such example solutions are inefficient, simplistic, and technically deficient. For example, such example solutions are inefficient because such example solutions do not use a model deployment system that includes a plurality of specifically configured components for performing particular functions of model deployment. As a result, such example solutions cause computing devices and repositories to suffer from high latency, consume excessive processing power, and consume excessive memory. As another example, such example solutions are simplistic because such example solutions are not configured to receive and implement previously generated machine learning artifacts as well as generate machine learning artifacts using machine learning code. As another example, such example solutions are technically deficient because such example solutions are unable able to deploy machine learning artifacts or machine learning images based on the type of application that a machine learning artifact or a machine learning image is being deployed to by the model deployment system. Accordingly, there is a need for systems, apparatuses, methods, and computer program products that are able to perform model deployment in an efficient, a sophisticated, and a technically sufficient manner.

Thus, to address these and/or other issues related to such example solutions, example systems, apparatuses, methods, and computer program products for model deployment disclosed herein. For example, an embodiment in this disclosure, described in greater detail below, includes a method that includes receiving machine learning code from a provisioning device. In some embodiments, the method includes generating a generated machine learning artifact by performing a machine learning training operation using the machine learning code. In some embodiments, the method includes generating a first machine learning image by performing a first build operation using the generated machine learning artifact. In some embodiments, the method includes deploying the first machine learning image to a first application. In some embodiments, the method includes establishing a first inferencing interface of between the first application and an endpoint. In some embodiments, the method includes causing the first application to generate a first inferencing processing response by applying a first inferencing processing request to the first machine learning image. In some embodiments, the method includes causing the first application to provide the first inferencing processing response to the endpoint via the first inferencing interface. Accordingly, the systems, apparatuses, methods, and computer program products provided herein enable model deployment in an efficient, a sophisticated, and a technically sufficient manner.

### Example Systems and Apparatuses

Embodiments of the present disclosure herein include systems, apparatuses, methods, and computer program products configured for model deployment. It should be readily appreciated that the embodiments of the apparatus, systems, methods, and computer program product described herein may be configured in various additional and alternative manners in addition to those expressly described herein.

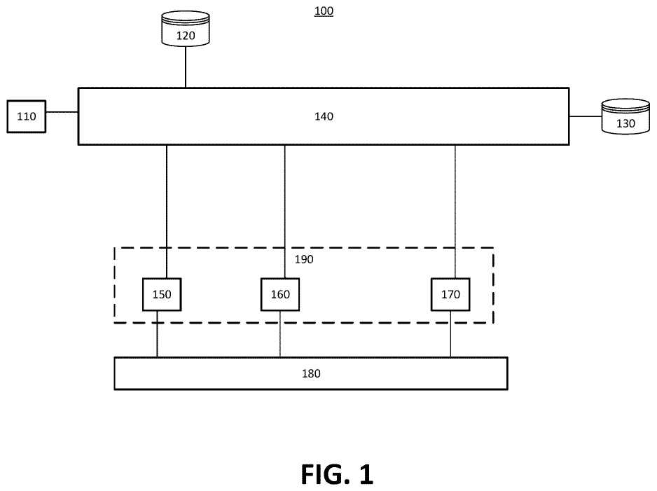

FIG. 1 illustrates an exemplary block diagram of an environment 100 in which embodiments of the present disclosure may operate. In some embodiments, the environment 100 may include a model deployment system 140. In some embodiments, for example, the model deployment system 140 may be configured for model deployment. The model deployment system 140 may be electronically and/or communicatively coupled to a provisioning device 110, an artifact repository 120, one or more image repositories 130, a cloud-native application 150, a container-based application 160, an edge-based application 170, and/or an endpoint 180. In some embodiments, the model deployment system 140 is configured via hardware, software, firmware, and/or a combination thereof, to perform data intake of one or more types of data associated with one or more of the provisioning device 110, the artifact repository 120, the one or more image repositories 130, the cloud-native application 150, the container-based application 160, the edge-based application 170, and/or the endpoint 180. Additionally, or alternatively, in some embodiments, the model deployment system 140 is configured via hardware, software, firmware, and/or a combination thereof, to generate and/or transmit command(s) that control, adjust, or otherwise impact operations of one or more of the provisioning device 110, the artifact repository 120, the one or more image repositories 130, the cloud-native application 150, the container-based application 160, the edge-based application 170, and/or the endpoint 180, for example for controlling one or more operations of the cloud-native application 150, the container-based application 160, and/or the edge-based application 170. Additionally or alternatively still, in some embodiments, the model deployment system 140 is configured via hardware, software, firmware, and/or a combination thereof, to perform data reporting and/or other data output process(es) associated with monitoring or otherwise analyzing operations of one or more of the provisioning device 110, the artifact repository 120, the one or more image repositories 130, the cloud-native application 150, the container-based application 160, the edge-based application 170, and/or the endpoint 180, for example for generating and/or outputting report(s) corresponding to such operations. For example, in various embodiments, the model deployment system 140 may be configured to execute and/or perform one or more operations and/or functions described herein.

In some embodiments, the environment 100 includes the provisioning device 110. In some embodiments, for example, the provisioning device 110 is configured to provide machine learning code and/or machine learning artifacts. The provisioning device 110 may be electronically and/or communicatively coupled to the model deployment system 140, the artifact repository 120, the one or more image repositories 130, the cloud-native application 150, the container-based application 160, the edge-based application 170, and/or the endpoint 180. In some embodiments, the provisioning device 110 is configured via hardware, software, firmware, and/or a combination thereof, to perform data intake of one or more types of data associated with one or more of the model deployment system 140, the artifact repository 120, the one or more image repositories 130, the cloud-native application 150, the container-based application 160, the edge-based application 170, and/or the endpoint 180. Additionally, or alternatively, in some embodiments, the provisioning device 110 is configured via hardware, software, firmware, and/or a combination thereof, to generate and/or transmit command(s) that control, adjust, or otherwise impact operations of one or more of the model deployment system 140, the artifact repository 120, the one or more image repositories 130, the cloud-native application 150, the container-based application 160, the edge-based application 170, and/or the endpoint 180. Additionally or alternatively still, in some embodiments, the provisioning device 110 is configured via hardware, software, firmware, and/or a combination thereof, to perform data reporting and/or other data output process(es) associated with monitoring or otherwise analyzing operations of one or more of the model deployment system 140, the artifact repository 120, the one or more image repositories 130, the cloud-native application 150, the container-based application 160, the edge-based application 170, and/or the endpoint 180. For example, in various embodiments, the provisioning device 110 may be configured to execute and/or perform one or more operations and/or functions described herein.

In some embodiments, the environment 100 includes a plurality of applications 190. In some embodiments, the plurality of applications 190 include the cloud-native application 150, the container-based application 160, and/or the edge-based application 170. In this regard, in some embodiments, the environment 100 includes the cloud-native application 150 (e.g., a databricks related cloud-native application). In some embodiments, for example, the cloud-native application 150 is configured to host and or facilitate operation of one or more machine learning artifacts and/or one or more machine learning images. The cloud-native application 150 may be electronically and/or communicatively coupled to the model deployment system 140, the artifact repository 120, the one or more image repositories 130, the provisioning device 110, the container-based application 160, the edge-based application 170, and/or the endpoint 180. In some embodiments, the cloud-native application 150 is configured via hardware, software, firmware, and/or a combination thereof, to perform data intake of one or more types of data associated with one or more of the model deployment system 140, the artifact repository 120, the one or more image repositories 130, the provisioning device 110, the container-based application 160, the edge-based application 170, and/or the endpoint 180. Additionally, or alternatively, in some embodiments, the cloud-native application 150 is configured via hardware, software, firmware, and/or a combination thereof, to generate and/or transmit command(s) that control, adjust, or otherwise impact operations of one or more of the model deployment system 140, the artifact repository 120, the one or more image repositories 130, the provisioning device 110, the container-based application 160, the edge-based application 170, and/or the endpoint 180. Additionally or alternatively still, in some embodiments, the cloud-native application 150 is configured via hardware, software, firmware, and/or a combination thereof, to perform data reporting and/or other data output process(es) associated with monitoring or otherwise analyzing operations of one or more of the model deployment system 140, the artifact repository 120, the one or more image repositories 130, the provisioning device 110, the container-based application 160, the edge-based application 170, and/or the endpoint 180. For example, in various embodiments, the cloud-native application 150 may be configured to execute and/or perform one or more operations and/or functions described herein.

In some embodiments, the environment 100 includes the container-based application 160 (e.g., a Kubernetes cluster related container-based application). In some embodiments, for example, the container-based application 160 is configured to host and or facilitate operation of one or more machine learning artifacts and/or one or more machine learning images. The container-based application 160 may be electronically and/or communicatively coupled to the model deployment system 140, the artifact repository 120, the one or more image repositories 130, the cloud-native application 150, the provisioning device 110, the edge-based application 170, and/or the endpoint 180. In some embodiments, the container-based application 160 is configured via hardware, software, firmware, and/or a combination thereof, to perform data intake of one or more types of data associated with one or more of the model deployment system 140, the artifact repository 120, the one or more image repositories 130, the cloud-native application 150, the provisioning device 110, the edge-based application 170, and/or the endpoint 180. Additionally, or alternatively, in some embodiments, the container-based application 160 is configured via hardware, software, firmware, and/or a combination thereof, to generate and/or transmit command(s) that control, adjust, or otherwise impact operations of one or more of the model deployment system 140, the artifact repository 120, the one or more image repositories 130, the cloud-native application 150, the provisioning device 110, the edge-based application 170, and/or the endpoint 180. Additionally or alternatively still, in some embodiments, the container-based application 160 is configured via hardware, software, firmware, and/or a combination thereof, to perform data reporting and/or other data output process(es) associated with monitoring or otherwise analyzing operations of one or more of the model deployment system 140, the artifact repository 120, the one or more image repositories 130, the cloud-native application 150, the provisioning device 110, the edge-based application 170, and/or the endpoint 180. For example, in various embodiments, the container-based application 160 may be configured to execute and/or perform one or more operations and/or functions described herein.

In some embodiments, the environment 100 includes the edge-based application 170. In some embodiments, for example, the edge-based application 170 is configured to host and or facilitate operation of one or more machine learning artifacts and/or one or more machine learning images. The edge-based application 170 may be electronically and/or communicatively coupled to the model deployment system 140, the artifact repository 120, the one or more image repositories 130, the cloud-native application 150, the provisioning device 110, the container-based application 160, and/or the endpoint 180. In some embodiments, the edge-based application 170 is configured via hardware, software, firmware, and/or a combination thereof, to perform data intake of one or more types of data associated with one or more of the model deployment system 140, the artifact repository 120, the one or more image repositories 130, the cloud-native application 150, the provisioning device 110, the container-based application 160, and/or the endpoint 180. Additionally, or alternatively, in some embodiments, the edge-based application 170 is configured via hardware, software, firmware, and/or a combination thereof, to generate and/or transmit command(s) that control, adjust, or otherwise impact operations of one or more of the model deployment system 140, the artifact repository 120, the one or more image repositories 130, the cloud-native application 150, the provisioning device 110, the container-based application 160, and/or the endpoint 180. Additionally or alternatively still, in some embodiments, the edge-based application 170 is configured via hardware, software, firmware, and/or a combination thereof, to perform data reporting and/or other data output process(es) associated with monitoring or otherwise analyzing operations of one or more of the model deployment system 140, the artifact repository 120, the one or more image repositories 130, the cloud-native application 150, the provisioning device 110, the container-based application 160, and/or the endpoint 180. For example, in various embodiments, the edge-based application 170 may be configured to execute and/or perform one or more operations and/or functions described herein.

In some embodiments, the environment 100 includes the artifact repository 120. In some embodiments, the artifact repository 120 is configured to receive, store, and/or transmit data. In some embodiments, the artifact repository 120 may be associated with machine learning artifacts and/or the like. In some embodiments, the machine learning artifacts may be received from the model deployment system 140. In some embodiments, the artifact repository 120 is electronically and/or communicatively coupled to the model deployment system 140, the edge-based application 170, the one or more image repositories 130, the cloud-native application 150, the provisioning device 110, the container-based application 160, and/or the endpoint 180.

In some embodiments, the environment 100 includes the one or more image repositories 130. In some embodiments, the one or more image repositories 130 are configured to receive, store, and/or transmit data. In some embodiments, the one or more image repositories 130. may be associated with machine learning images and/or the like. In some embodiments, the machine learning images may be received from the model deployment system 140. In some embodiments, the one or more image repositories 130 are electronically and/or communicatively coupled to the model deployment system 140, the edge-based application 170, the artifact repository 120, the cloud-native application 150, the provisioning device 110, the container-based application 160, and/or the endpoint 180.

In some embodiments, the environment 100 includes the endpoint 180. In some embodiments, endpoint 180 may be electronically and/or communicatively coupled to the model deployment system 140, the edge-based application 170, the artifact repository 120, the cloud-native application 150, the provisioning device 110, the container-based application 160, and/or the one or more image repositories 130.

In some embodiments, the endpoint 180, the model deployment system 140, the edge-based application 170, the artifact repository 120, the cloud-native application 150, the provisioning device 110, the container-based application 160, and/or the one or more image repositories 130 may be electronically and/or communicatively coupled to each other and/or one or more other devices via a network. In some embodiments, such a network may be embodied in any of a myriad of network configurations. In some embodiments, the network may be a public network (e.g., the Internet). In some embodiments, the network may be a private network (e.g., an internal localized, or closed-off network between particular devices). In some other embodiments, the network may be a hybrid network (e.g., a network enabling internal communications between particular connected devices and external communications with other devices). In various embodiments, the network may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities, various embodiments are not limited to this configuration. In other embodiments, one or more components may be directly connected and/or share hardware or the like. For example, in some embodiments, the model deployment system 140 may include one or more of the cloud-native application 150, the edge-based application 170, and/or the container-based application 160.

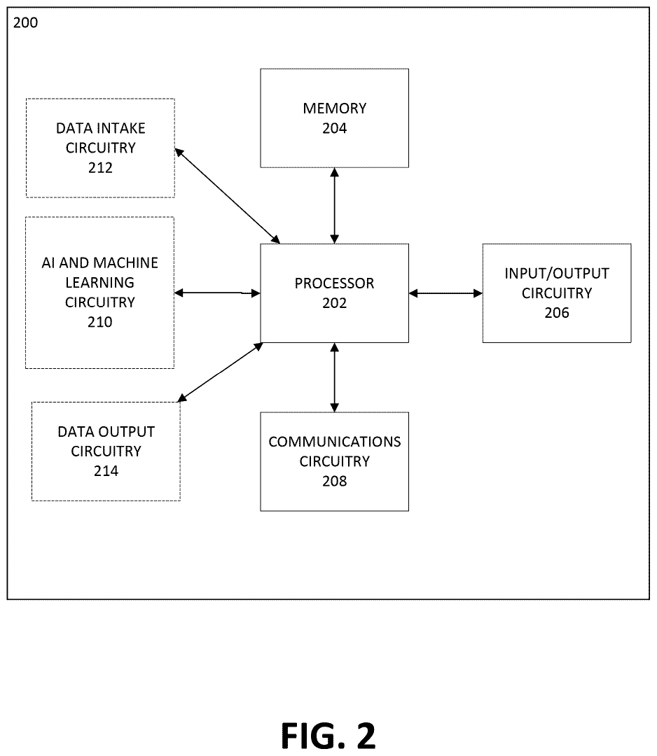

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, the endpoint 180, the model deployment system 140, the edge-based application 170, the artifact repository 120, the cloud-native application 150, the provisioning device 110, the container-based application 160, and/or the one or more image repositories 130. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of a model deployment system 140 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the environment 100. In some embodiments, the data intake circuitry 212 includes hardware, software, firmware, and/or a combination thereof, that communicates with one or more components of the environment 100 to receive particular data associated with such operations of the environment 100. Additionally, or alternatively, in some embodiments, the data intake circuitry 212 includes hardware, software, firmware, and/or a combination thereof, that retrieves particular data associated with the environment 100 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data using learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

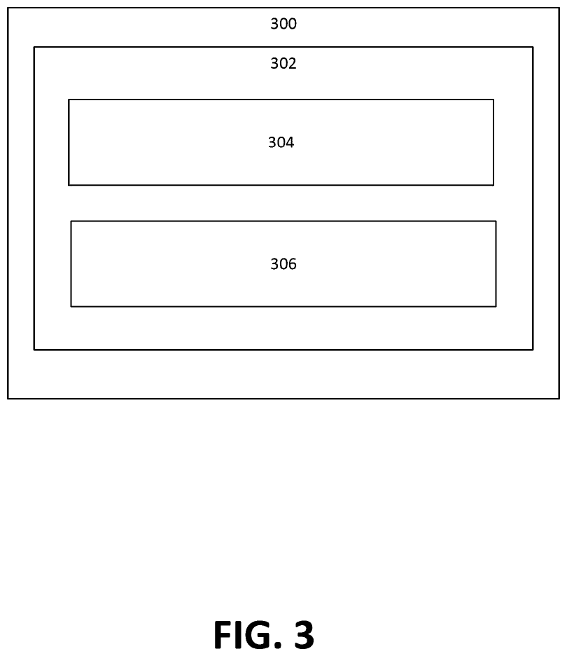

With reference to FIGS. 1-3, in some embodiments, the model deployment system 140 is configured to receive machine learning code. In some embodiments, machine learning code is computer programing code that can be used to generate a machine learning artifact and/or a machine learning image. For example, machine learning code may be computer programing code that can be used to generate a machine learning artifact and/or a machine learning image by performing a machine learning training operation and/or a build operation. In some embodiments, machine learning code is in a machine-readable format. In some embodiments, machine learning code in a machine-readable format is not readable or understandable by a user (e.g., a human), such as a user associated with the model deployment system 140. In some embodiments, machine learning code is associated with a bring your own machine learning (BYMOL) architecture.

In some embodiments, the model deployment system 140 is configured to receive machine learning code from the provisioning device 110. In this regard, in some embodiments, the provisioning device 110 is configured to transmit machine learning code to the model deployment system 140. For example, the provisioning system may be configured to transmit machine learning code to the model deployment system 140 after the machine learning code has been provided to the provisioning device 110. In some embodiments, the model deployment system 140 is configured to request machine learning code from the provisioning device 110. In some embodiments, requesting machine learning code from the provisioning device 110 causes the provisioning device 110 to transmit machine learning code to the model deployment system 140.

In some embodiments, the model deployment system 140 is configured to perform a software composition operation on the machine learning code. For example, the model deployment system 140 may be configured to perform a software composition operation on machine learning code after receiving the machine learning code and before using the machine learning code to generate a machine learning artifact.

In some embodiments, a software composition operation includes the model deployment system 140 being configured to scan and/or analyze machine learning code to identify one or more security risks associated with the machine learning code. For example, the one or more security risks associated with machine learning code may include malware, such as malware configured to compromise the model deployment system 140 and/one or more of the cloud-native application 150, the container-based application 160, the edge-based application 170. In some embodiments, a software composition operation includes the model deployment system 140 being configured to scan and/or analyze machine learning code to identify one or more open-source risks associated with the machine learning code. For example, the one or more open-source risks associated with machine learning code may include portions of the machine learning code associated with copyleft licenses and/or other non-permissive licenses.

In some embodiments, a machine learning artifact is a data object or data entity that is generated by a training operation (e.g., a machine learning related training operation). In this regard, in some embodiments, a machine learning artifact may be a trained machine learning model and/or weighting parameters used by a trained machine learning model. Additionally, or alternatively, a machine learning artifact may be a partially trained machine learning model and/or weighting parameters used by a partially trained machine learning model. Additionally, or alternatively, a machine learning artifact may be data generated during a training operation and/or weighting parameters associated with the data generated during a training operation. In some embodiments, a machine learning artifact is associated with the cloud-native application 150. In this regard, for example, a machine learning artifact may be configured such that it can be operated, executed, and/or run by the cloud-native application 150. In some embodiments, a machine learning artifact is associated with a bring your own machine learning (BYMOL) architecture. Said differently, in some embodiments, a machine learning artifact may be a packaged version of a trained machine learning model. For example, if the framework used for training a machine learning model is Sklearn then a machine learning artifact would include a Pickle file and associated metadata. As another example, if the framework used for training a machine learning model is Tensorflow then a machine learning artifact would include a PB file and associated metadata.

In some embodiments, the model deployment system 140 is configured to generate a machine learning artifact. For example, the model deployment system 140 may be configured to generate a generated machine learning artifact. In some embodiments, a generated machine learning artifact is a machine learning artifact that has been generated by the model deployment system 140. In some embodiments, the model deployment system 140 is configured to generate a machine learning artifact using machine learning code (e.g., machine learning code received from the provisioning device 110). In some embodiments, the model deployment system 140 is configured to generate a machine learning artifact by performing a training operation using the machine learning code. In this regard, in some embodiments, the model deployment system 140 is configured to perform one or more machine learning related training operations to generate a machine learning artifact. For example, by performing a training operation using machine learning code the model deployment system 140 may be configured to generate a machine learning artifact representative and/or indicative of a trained machine learning model, a partially trained machine learning model, and/or the like.

In some embodiments, the model deployment system 140 is configured to receive a machine learning artifact. For example, the model deployment system 140 may be configured to receive a received machine learning artifact. In some embodiments, a received machine learning artifact is a machine learning artifact that is received by the model deployment system 140 (e.g., from the provisioning device 110). In some embodiments, the model deployment system 140 is configured to receive a machine learning artifact from the provisioning device 110 and/or one or more other computing devices external to the model deployment system 140. In this regard, for example, the provisioning device 110 and/or one or more other computing devices external to the model deployment system 140 may be configured to generate a machine learning artifact and provide the machine learning artifact to the model deployment system 140.

In some embodiments, a machine learning image is a data object or data entity that is generated by a build operation (e.g., a machine learning related build operation). In this regard, in some embodiments, a machine learning image may be a trained machine learning model and/or dependencies used by a trained machine learning model. Additionally, or alternatively, a machine learning image may be a partially trained machine learning model and/or dependencies used by a partially trained machine learning model. Additionally, or alternatively, a machine learning image may be data generated during a build operation and/or dependencies associated with the data generated during a build operation. In some embodiments, a machine learning image is associated with the container-based application 160 and/or the edge-based application 170. In this regard, for example, a machine learning image may be configured such that it can be operated, executed, and/or run by the container-based application 160 and/or the edge-based application 170. Said differently, for example, a machine learning image may include a model inferencing file that will be used by the machine learning image for generating inferencing processing responses.

In some embodiments, the model deployment system 140 is configured to generate a machine learning image. For example, the model deployment system 140 may be configured to generate a first machine learning image. As another example, the model deployment system 140 may be configured to generate a second machine learning image. In some embodiments, the model deployment system 140 is configured to generate a machine learning image using a machine learning artifact. For example, the model deployment system 140 may be configured to generate a machine learning image (e.g., a first machine learning image) using a machine learning artifact generated by the model deployment system 140. As another example, the model deployment system 140 may be configured to generate a machine learning image (e.g., a second machine learning image) using a machine learning artifact received by the model deployment system 140 (e.g., received from the provisioning device 110). In this regard, in some embodiments, the model deployment system 140 is configured to perform one or more build operations to generate a machine learning image using a machine learning artifact. For example, the model deployment system 140 may be configured to perform a first build operation and a second build operation.

In some embodiments, a machine learning model, such as a machine learning artifact and/or a machine learning image, is a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to be used to generate one or more inferencing processing responses. In this regard, in some embodiments, a machine learning model may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques.

In some embodiments, the model deployment system 140 is configured to register machine learning code. In some embodiments, registering machine learning code includes the model deployment system 140 being configured to assign the machine learning code a machine learning code identifier that uniquely identifies the machine learning code in the model deployment system 140. In some embodiments, the machine learning code identifier may be representative and/or indicative of when a particular portion of machine learning code was received and where the machine learning code was received from (e.g., the provisioning device 110).

In some embodiments, the model deployment system 140 is configured to register a machine learning artifact. In some embodiments, registering a machine learning artifact includes the model deployment system 140 being configured to assign the machine learning artifact a machine learning artifact identifier that uniquely identifies the machine learning artifact in the model deployment system 140 and/or in one of the plurality of applications 190. In some embodiments, the machine learning artifact identifier may be representative and/or indicative of when a machine learning artifact was received, when a machine learning artifact was generated, and/or which application of the plurality of applications 190 is associated with a machine learning artifact (e.g., which application a machine learning artifact is deployed to or will be deployed to).

In some embodiments, the model deployment system 140 is configured to store a machine learning artifact in the artifact repository 120. For example, the model deployment system 140 may be configured to store a machine learning artifact in the artifact repository 120 after receiving the machine learning artifact. As another example, the model deployment system 140 may be configured to store a machine learning artifact in the artifact repository 120 after generating the machine learning artifact. In some embodiments, the model deployment system 140 is configured to store a machine learning artifact in the artifact repository 120 such that the machine learning artifact is associated with its machine learning artifact identifier. In this regard, for example, a machine learning artifact may be searchable in the artifact repository 120 using the machine learning artifact's corresponding machine learning artifact identifier.

In some embodiments, the model deployment system 140 is configured to register a machine learning image. In some embodiments, registering a machine learning image includes the model deployment system 140 being configured to assign the machine learning image a machine learning image identifier that uniquely identifies the machine learning image in the model deployment system 140 and/or in one of the plurality of applications 190. In some embodiments, the machine learning image identifier may be representative and/or indicative of when a machine learning image was received, when a machine learning image was generated, and/or which application of the plurality of applications 190 is associated with a machine learning image (e.g., which application a machine learning image is deployed to or will be deployed to).

In some embodiments, the model deployment system 140 is configured to store a machine learning image in the one or more image repositories 130. For example, the model deployment system 140 may be configured to store a machine learning image in the one or more image repositories 130 after receiving the machine learning image. As another example, the model deployment system 140 may be configured to store a machine learning image in the one or more image repositories 130 after generating the machine learning image. In some embodiments, the model deployment system 140 is configured to store a machine learning image in the one or more image repositories 130 such that the machine learning image is associated with its machine learning image identifier. In this regard, for example, a machine learning image may be searchable in the one or more image repositories 130 using the machine learning image's corresponding machine learning image identifier.

In some embodiments, the model deployment system 140 is configured to deploy a machine learning artifact to one or more of the plurality of applications 190. In some embodiments, the model deployment system 140 is configured to deploy a machine learning artifact that the model deployment system 140 generated. For example, the model deployment system 140 may be configured to deploy a generated machine learning artifact that was generated by the model deployment system 140 to the cloud-native application 150. In some embodiments, the model deployment system 140 is configured to deploy a machine learning artifact that the model deployment system 140 received. For example, the model deployment system 140 may be configured to deploy a received machine learning artifact that was received by the model deployment system 140 to the cloud-native application 150.

In some embodiments, deploying a machine learning artifact to an application of the plurality of applications 190 enables the application to operate, execute, run, and/or host the machine learning artifact. In this regard, for example, deploying a machine learning artifact to an application of the plurality of applications 190 enables the application to operate, execute, run, and/or host the machine learning artifact such that the machine learning artifact can be used to generate inferencing processing responses based on inferencing processing requests.

In some embodiments, the model deployment system 140 is configured to deploy a machine learning image to one or more of the plurality of applications 190. In some embodiments, the model deployment system 140 is configured to deploy a machine learning image that the model deployment system 140 generated. For example, the model deployment system 140 may be configured to deploy a first machine learning image that was generated by the model deployment system 140 to the container-based application 160 and/or the edge-based application 170. As another example, the model deployment system 140 may be configured to deploy a second machine learning image that was generated by the model deployment system 140 to the container-based application 160 and/or the edge-based application 170.

In some embodiments, deploying a machine learning image to an application of the plurality of applications 190 enables the application to operate, execute, run, and/or host the machine learning image. In this regard, for example, deploying a machine learning image to an application of the plurality of applications 190 enables the application to operate, execute, run, and/or host the machine learning image such that the machine learning image can be used to generate inferencing processing responses based on inferencing processing requests.

In some embodiments, the model deployment system 140 is configured to establish an inferencing interface between at least one of the plurality of applications 190 and the endpoint 180. In some embodiments, an inferencing interface is a gateway, communication channel, application programming interface (API), and/or the like that enables data to be transmitted between the endpoint 180 and one or more of the plurality of applications 190. For example, an inferencing interface is a gateway, communication channel, application programming interface (API), and/or the like that enables inferencing processing requests and/or inferencing processing responses to be transmitted between the endpoint 180 and one or more of the plurality of applications 190. In this regard, in some embodiments, the model deployment system 140 is configured to establish a cloud-native application inferencing interface between the cloud-native application 150 and the endpoint 180 such that inferencing processing requests and/or inferencing processing responses can be transmitted between the endpoint 180 and the cloud-native application 150. In some embodiments, the model deployment system 140 is configured to establish a container-based application inferencing interface between the container-based application 160 and the endpoint 180 such that inferencing processing requests and/or inferencing processing responses can be transmitted between the endpoint 180 and the container-based application 160. In some embodiments, the model deployment system 140 is configured to establish an edge-based application inferencing interface between the edge-based application 170 and the endpoint 180 such that inferencing processing requests and/or inferencing processing responses can be transmitted between the endpoint 180 and the edge-based application 170. In some embodiments, a container-based application inferencing interface and/or an edge-based application inferencing interface correspond to a first inferencing interface.

In some embodiments, the endpoint 180 is a computing device through which the plurality of applications 190 and/or the model deployment system 140 may be accessed and/or operated. In this regard, in some embodiments, the endpoint 180 is configured to provide one or more inferencing processing requests to one or more of the plurality of applications 190. For example, the endpoint 180 may be configured to provide a first inferencing processing request to the container-based application 160 and/or the edge-based application 170. As another example, the endpoint 180 may be configured to provide a second inferencing processing request to the cloud-native application 150. As another example, the endpoint 180 may be configured to provide a third inferencing processing request to the cloud-native application 150. As another example, the endpoint 180 may be configured to provide a fourth inferencing processing request to the container-based application 160 and/or the edge-based application 170.

In some embodiments, the endpoint 180 is configured to receive one or more inferencing processing responses from one or more of the plurality of applications 190. For example, the endpoint 180 may be configured to receive a first inferencing processing response from the container-based application 160 and/or the edge-based application 170. As another example, the endpoint 180 may be configured to receive a second inferencing processing response from the cloud-native application 150. As another example, the endpoint 180 may be configured to receive a third inferencing processing response from the cloud-native application 150. As another example, the endpoint 180 may be configured to receive a fourth inferencing processing response from the container-based application 160 and/or the edge-based application 170.

In some embodiments, the model deployment system 140 is configured to instruct the endpoint 180 which of the plurality of applications 190 that the endpoint 180 should provide an inferencing processing request to. For example, the model deployment system 140 may be configured to instruct the endpoint 180 which of the plurality of applications 190 that the endpoint 180 should provide a inferencing processing request to based on which machine learning artifacts and/or machine learning images the model deployment system 140 has deployed to each of the plurality of applications 190.

In some embodiments, an inferencing processing request is a data object that is representative and/or indicative of an input to a machine learning artifact and/or a machine learning image. For example, an inferencing processing request may be a data object that is representative and/or indicative of an unprocessed image. In this regard, in some embodiments, an unprocessed image is an image that has not been processed using a machine learning artifact and/or a machine learning image (e.g., a photo or drawing that has not been processed using a machine learning artifact and/or a machine learning image). In some embodiments, an inferencing processing response is a data object that is representative and/or indicative of an output of a machine learning artifact and/or a machine learning image. For example, an inferencing processing response may be a data object that is representative and/or indicative of a processed image. In this regard, in some embodiments, a processed image is an image that has been processed using a machine learning artifact and/or a machine learning image (e.g., a photo or drawing that has been processed using a machine learning artifact and/or a machine learning image). For example, an image may be processed in a machine learning artifact and/or a machine learning image to adjust the image's exposure, white balance, colors, and/or the like.

In some embodiments, the model deployment system 140 is configured to cause one or more of the plurality of applications 190 to generate at least one inferencing processing response. For example, the model deployment system 140 may be configured to cause the container-based application 160 and/or the edge-based application 170 to generate a first inferencing processing response. As another example, the model deployment system 140 may be configured to cause the cloud-native application 150 to generate a second inferencing processing response. As another example, the model deployment system 140 may be configured to cause the cloud-native application 150 to generate a third inferencing processing response. As another example, the model deployment system 140 may be configured to cause the container-based application 160 and/or the edge-based application 170 to generate a fourth inferencing processing response.

In some embodiments, the model deployment system 140 is configured to cause one or more of the plurality of applications 190 to generate at least one inferencing processing response by applying an inferencing processing request to a machine learning image. In this regard, in some embodiments, the model deployment system 140 is configured to cause an application of the plurality of applications 190 to generate at least one inferencing processing response by causing a machine learning image associated with the application to operate, execute, and/or run using an inferencing processing request as an input to generate an inferencing processing response. For example, the model deployment system 140 may be configured to cause the container-based application 160 and/or the edge-based application 170 (e.g., a first application) to generate a first inferencing processing response by applying a first inferencing processing request to a first machine learning image. In this regard, in some embodiments, the model deployment system 140 is configured to cause the container-based application 160 and/or the edge-based application 170 to generate a first inferencing processing response by causing a first machine learning image associated with the container-based application 160 and/or the edge-based application 170 to operate, execute, and/or run using the first inferencing processing request as an input to generate the first inferencing processing response. As another example, the model deployment system 140 may be configured to cause the container-based application 160 and/or the edge-based application 170 (e.g., a first application) to generate a fourth inferencing processing response by applying a fourth inferencing processing request to a second machine learning image. In this regard, in some embodiments, the model deployment system 140 is configured to cause the container-based application 160 and/or the edge-based application 170 to generate a fourth inferencing processing response by causing a second machine learning image associated with the container-based application 160 and/or the edge-based application 170 to operate, execute, and/or run using the fourth inferencing processing request as an input to generate the fourth inferencing processing response.

In some embodiments, the model deployment system 140 is configured to cause one or more of the plurality of applications 190 to generate at least one inferencing processing response by applying an inferencing processing request to a machine learning artifact. In this regard, in some embodiments, the model deployment system 140 is configured to cause an application of the plurality of applications 190 to generate at least one inferencing processing response by causing a machine learning artifact associated with the application to operate, execute, and/or run using an inferencing processing request as an input to generate an inferencing processing response. For example, the model deployment system 140 may be configured to cause the cloud-native application 150 to generate a second inferencing processing response by applying a second inferencing processing request to a generated machine learning artifact. In this regard, in some embodiments, the model deployment system 140 is configured to cause the cloud-native application 150 to generate a second inferencing processing response by causing a generated machine learning artifact associated with the cloud-native application 150 to operate, execute, and/or run using the second inferencing processing request as an input to generate the second inferencing processing response. As another example, the model deployment system 140 may be configured to cause the cloud-native application 150 to generate a third inferencing processing response by applying a third inferencing processing request to a received machine learning artifact. In this regard, in some embodiments, the model deployment system 140 is configured to cause the cloud-native application 150 to generate a third inferencing processing response by causing a received machine learning artifact associated with the cloud-native application 150 to operate, execute, and/or run using the third inferencing processing request as an input to generate the third inferencing processing response.

In some embodiments, the model deployment system 140 is configured to generate a model deployment operations interface component 302. In some embodiments, the model deployment operations interface component 302 includes a model deployment display element 304. In some embodiments, the model deployment display element 304 is configured to display where machine learning artifacts are deployed. For example, the model deployment display element 304 may be configured to display that a generated machine learning artifact is deployed to the cloud-native application 150. As another example, the model deployment display element 304 may be configured to display that a received machine learning artifact is deployed to the cloud-native application 150. In some embodiments, the model deployment display element 304 is configured to display where machine learning images are deployed. For example, the model deployment display element 304 may be configured to display that a first machine learning image is deployed to the container-based application 160 and/or the edge-based application 170. As another example, the model deployment display element 304 may be configured to display that a second machine learning image is deployed to the container-based application 160 and/or the edge-based application 170.

In some embodiments, the model deployment operations interface component 302 includes a software composition display element 306. In some embodiments, the software composition display element 306 is configured to display a result associated with a software composition operation. For example, the software composition display element 306 may be configured to display a result associated with a software composition operation that indicates that machine learning code includes malware. As another example, the software composition display element 306 is configured to display a result associated with a software composition operation that indicates that machine learning code includes one or more open-source risks (e.g., a portion of the machine learning code is associated with a copyleft license).

In some embodiments, the model deployment system 140 is configured to cause the model deployment operations interface element to be rendered to a model deployment operations interface 300. In some embodiments, the model deployment operations interface 300 is provided at the provisioning device 110, the model deployment system 140, the endpoint 180, a device associated with the cloud-native application 150, a device associated with the container-based application 160, and/or a device associated with the edge-based application 170.

### Example Methods

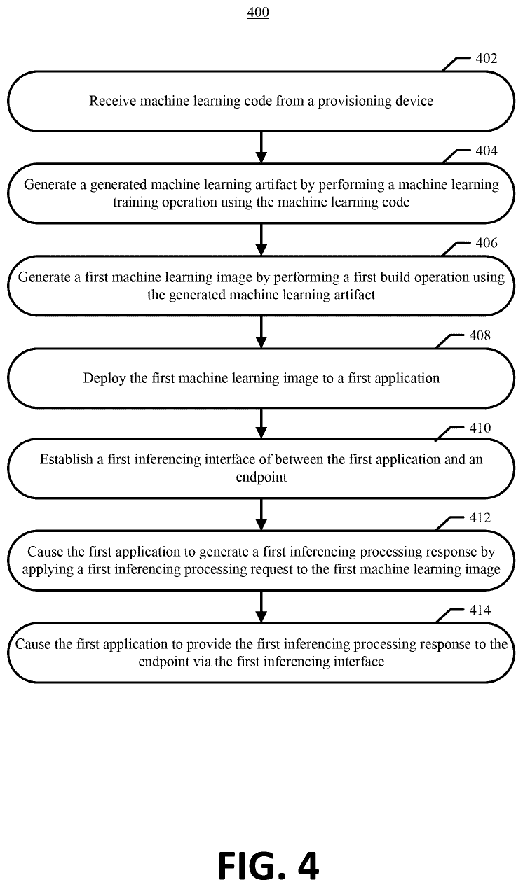

Referring now to FIG. 4, a flowchart providing an example method 400 is illustrated. In this regard, FIG. 4 illustrates operations that may be performed by the provisioning device 110, the model deployment system 140, the endpoint 180, a device associated with the cloud-native application 150, a device associated with the container-based application 160, and/or a device associated with the edge-based application 170, the artifact repository 120, the one or more image repositories 130, and/or the like. In some embodiments, the method 400 includes operations for at least causing a first application to provide a first inferencing processing response to the endpoint 180 via a first inferencing interface. In some embodiments, the example method 400 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 400.

As shown in block 402, the method 400 may include receiving machine learning code from a provisioning device. As described above, in some embodiments, machine learning code is computer programing code that can be used to generate a machine learning artifact and/or a machine learning image. For example, machine learning code may be computer programing code that can be used to generate a machine learning artifact and/or a machine learning image by performing a machine learning training operation and/or a build operation. In some embodiments, machine learning code is in a machine-readable format. In some embodiments, machine learning code in a machine-readable format is not readable or understandable by a user (e.g., a human), such as a user associated with the model deployment system. In some embodiments, machine learning code is associated with a bring your own machine learning (BYMOL) architecture.

In some embodiments, the model deployment system is configured to receive machine learning code from the provisioning device. In this regard, in some embodiments, the provisioning device is configured to transmit machine learning code to the model deployment system. For example, the provisioning system may be configured to transmit machine learning code to the model deployment system after the machine learning code has been provided to the provisioning device. In some embodiments, the model deployment system is configured to request machine learning code from the provisioning device. In some embodiments, requesting machine learning code from the provisioning device causes the provisioning device to transmit machine learning code to the model deployment system.

As shown in block 404, the method 400 may include generating a generated machine learning artifact by performing a machine learning training operation using the machine learning code. As described above, in some embodiments, a machine learning artifact is a data object or data entity that is generated by a training operation (e.g., a machine learning related training operation). In this regard, in some embodiments, a machine learning artifact may be a trained machine learning model and/or weighting parameters used by a trained machine learning model. Additionally, or alternatively, a machine learning artifact may be a partially trained machine learning model and/or weighting parameters used by a partially trained machine learning model. Additionally, or alternatively, a machine learning artifact may be data generated during a training operation and/or weighting parameters associated with the data generated during a training operation. In some embodiments, a machine learning artifact is associated with the cloud-native application. In this regard, for example, a machine learning artifact may be configured such that it can be operated, executed, and/or run by the cloud-native application. In some embodiments, a machine learning artifact is associated with a bring your own machine learning (BYMOL) architecture. Said differently, in some embodiments, a machine learning artifact may be a packaged version of a trained machine learning model. For example, if the framework used for training a machine learning model is Sklearn then a machine learning artifact would include a Pickle file and associated metadata. As another example, if the framework used for training a machine learning model is Tensorflow then a machine learning artifact would include a PB file and associated metadata.

In some embodiments, the model deployment system is configured to generate a machine learning artifact. For example, the model deployment system may be configured to generate a generated machine learning artifact. In some embodiments, a generated machine learning artifact is a machine learning artifact that has been generated by the model deployment system. In some embodiments, the model deployment system is configured to generate a machine learning artifact using machine learning code (e.g., machine learning code received from the provisioning device). In some embodiments, the model deployment system is configured to generate a machine learning artifact by performing a training operation using the machine learning code. In this regard, in some embodiments, the model deployment system is configured to perform one or more machine learning related training operations to generate a machine learning artifact. For example, by performing a training operation using machine learning code the model deployment system may be configured to generate a machine learning artifact representative and/or indicative of a trained machine learning model, a partially trained machine learning model, and/or the like.

As shown in block 406, the method 400 may include generating a first machine learning image by performing a first build operation using the generated machine learning artifact. As described above, in some embodiments, a machine learning image may be a trained machine learning model and/or dependencies used by a trained machine learning model. Additionally, or alternatively, a machine learning image may be a partially trained machine learning model and/or dependencies used by a partially trained machine learning model. Additionally, or alternatively, a machine learning image may be data generated during a build operation and/or dependencies associated with the data generated during a build operation. In some embodiments, a machine learning image is associated with the container-based application and/or the edge-based application. In this regard, for example, a machine learning image may be configured such that it can be operated, executed, and/or run by the container-based application and/or the edge-based application. Said differently, for example, a machine learning image may include a model inferencing file that will be used by the machine learning image for generating inferencing processing responses.

In some embodiments, the model deployment system is configured to generate a machine learning image. For example, the model deployment system may be configured to generate a first machine learning image. As another example, the model deployment system may be configured to generate a second machine learning image. In some embodiments, the model deployment system is configured to generate a machine learning image using a machine learning artifact. For example, the model deployment system may be configured to generate a machine learning image (e.g., a first machine learning image) using a machine learning artifact generated by the model deployment system. As another example, the model deployment system may be configured to generate a machine learning image (e.g., a second machine learning image) using a machine learning artifact received by the model deployment system (e.g., received from the provisioning device). In this regard, in some embodiments, the model deployment system is configured to perform one or more build operations to generate a machine learning image using a machine learning artifact. For example, the model deployment system may be configured to perform a first build operation and a second build operation.

As shown in block 408, the method 400 may include deploying the first machine learning image to a first application. As described above, in some embodiments, the model deployment system is configured to deploy a machine learning image that the model deployment system generated. For example, the model deployment system may be configured to deploy a first machine learning image that was generated by the model deployment system to the container-based application and/or the edge-based application. As another example, the model deployment system may be configured to deploy a second machine learning image that was generated by the model deployment system to the container-based application and/or the edge-based application.

In some embodiments, deploying a machine learning image to an application of the plurality of applications enables the application to operate, execute, run, and/or host the machine learning image. In this regard, for example, deploying a machine learning image to an application of the plurality of applications enables the application to operate, execute, run, and/or host the machine learning image such that the machine learning image can be used to generate inferencing processing responses based on inferencing processing requests.

As shown in block 410, the method 400 may include establishing a first inferencing interface of between the first application and an endpoint. As described above, in some embodiments, an inferencing interface is a gateway, communication channel, application programming interface (API), and/or the like that enables data to be transmitted between the endpoint and one or more of the plurality of applications. For example, an inferencing interface is a gateway, communication channel, application programming interface (API), and/or the like that enables inferencing processing requests and/or inferencing processing responses to be transmitted between the endpoint and one or more of the plurality of applications. In this regard, in some embodiments, the model deployment system is configured to establish a cloud-native application inferencing interface between the cloud-native application and the endpoint such that inferencing processing requests and/or inferencing processing responses can be transmitted between the endpoint and the cloud-native application. In some embodiments, the model deployment system is configured to establish a container-based application inferencing interface between the container-based application and the endpoint such that inferencing processing requests and/or inferencing processing responses can be transmitted between the endpoint and the container-based application. In some embodiments, the model deployment system is configured to establish an edge-based application inferencing interface between the edge-based application and the endpoint such that inferencing processing requests and/or inferencing processing responses can be transmitted between the endpoint and the edge-based application. In some embodiments, a container-based application inferencing interface and/or an edge-based application inferencing interface correspond to a first inferencing interface.

As shown in block 412, the method 400 may include causing the first application to generate a first inferencing processing response by applying a first inferencing processing request to the first machine learning image. As described above, in some embodiments, an inferencing processing request is a data object that is representative and/or indicative of an input to a machine learning artifact and/or a machine learning image. For example, an inferencing processing request may be a data object that is representative and/or indicative of an unprocessed image. In this regard, in some embodiments, an unprocessed image is an image that has not been processed using a machine learning artifact and/or a machine learning image (e.g., a photo or drawing that has not been processed using a machine learning artifact and/or a machine learning image).

As shown in block 414, the method 400 may include causing the first application to provide the first inferencing processing response to the endpoint via the first inferencing interface. As described above, in some embodiments, an inferencing processing response is a data object that is representative and/or indicative of an output of a machine learning artifact and/or a machine learning image. For example, an inferencing processing response may be a data object that is representative and/or indicative of a processed image. In this regard, in some embodiments, a processed image is an image that has been processed using a machine learning artifact and/or a machine learning image (e.g., a photo or drawing that has been processed using a machine learning artifact and/or a machine learning image). For example, an image may be processed in a machine learning artifact and/or a machine learning image to adjust the image's exposure, white balance, colors, and/or the like.

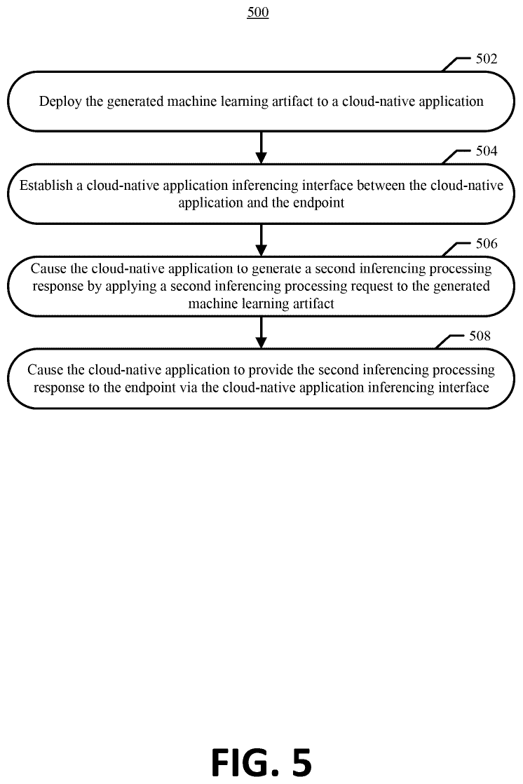

Referring now to FIG. 5, a flowchart providing an example method 500 is illustrated. In this regard, FIG. 5 illustrates operations that may be performed by the provisioning device 110, the model deployment system 140, the endpoint 180, a device associated with the cloud-native application 150, a device associated with the container-based application 160, and/or a device associated with the edge-based application 170, the artifact repository 120, the one or more image repositories 130, and/or the like. In some embodiments, the method 500 includes operations for at least causing the cloud-native application to provide the second inferencing processing response to the endpoint 180 via the cloud-native application inferencing interface. In some embodiments, the example method 500 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500.

As shown in block 502, the method 500 may include deploying the generated machine learning artifact to a cloud-native application. As described above, in some embodiments, the model deployment system is configured to deploy a machine learning artifact that the model deployment system generated. For example, the model deployment system may be configured to deploy a generated machine learning artifact that was generated by the model deployment system to the cloud-native application. In some embodiments, the model deployment system is configured to deploy a machine learning artifact that the model deployment system received. For example, the model deployment system may be configured to deploy a received machine learning artifact that was received by the model deployment system to the cloud-native application.

In some embodiments, deploying a machine learning artifact to an application of the plurality of applications enables the application to operate, execute, run, and/or host the machine learning artifact. In this regard, for example, deploying a machine learning artifact to an application of the plurality of applications enables the application to operate, execute, run, and/or host the machine learning artifact such that the machine learning artifact can be used to generate inferencing processing responses based on inferencing processing requests.

As shown in block 504, the method 500 may include establishing a cloud-native application inferencing interface between the cloud-native application and the endpoint. As described above, in some embodiments, an inferencing interface is a gateway, communication channel, application programming interface (API), and/or the like that enables data to be transmitted between the endpoint and one or more of the plurality of applications. For example, an inferencing interface is a gateway, communication channel, application programming interface (API), and/or the like that enables inferencing processing requests and/or inferencing processing responses to be transmitted between the endpoint and one or more of the plurality of applications. In this regard, in some embodiments, the model deployment system is configured to establish a cloud-native application inferencing interface between the cloud-native application and the endpoint such that inferencing processing requests and/or inferencing processing responses can be transmitted between the endpoint and the cloud-native application. In some embodiments, the model deployment system is configured to establish a container-based application inferencing interface between the container-based application and the endpoint such that inferencing processing requests and/or inferencing processing responses can be transmitted between the endpoint and the container-based application. In some embodiments, the model deployment system is configured to establish an edge-based application inferencing interface between the edge-based application and the endpoint such that inferencing processing requests and/or inferencing processing responses can be transmitted between the endpoint and the edge-based application. In some embodiments, a container-based application inferencing interface and/or an edge-based application inferencing interface correspond to a first inferencing interface.

As shown in block 506, the method 500 may include causing the cloud-native application to generate a second inferencing processing response by applying a second inferencing processing request to the generated machine learning artifact. As described above, in some embodiments, an inferencing processing request is a data object that is representative and/or indicative of an input to a machine learning artifact and/or a machine learning image. For example, an inferencing processing request may be a data object that is representative and/or indicative of an unprocessed image. In this regard, in some embodiments, an unprocessed image is an image that has not been processed using a machine learning artifact and/or a machine learning image (e.g., a photo or drawing that has not been processed using a machine learning artifact and/or a machine learning image).

As shown in block 508, the method 500 may include causing the cloud-native application to provide the second inferencing processing response to the endpoint via the cloud-native application inferencing interface. As described above, in some embodiments, an inferencing processing response is a data object that is representative and/or indicative of an output of a machine learning artifact and/or a machine learning image. For example, an inferencing processing response may be a data object that is representative and/or indicative of a processed image. In this regard, in some embodiments, a processed image is an image that has been processed using a machine learning artifact and/or a machine learning image (e.g., a photo or drawing that has been processed using a machine learning artifact and/or a machine learning image). For example, an image may be processed in a machine learning artifact and/or a machine learning image to adjust the image's exposure, white balance, colors, and/or the like.

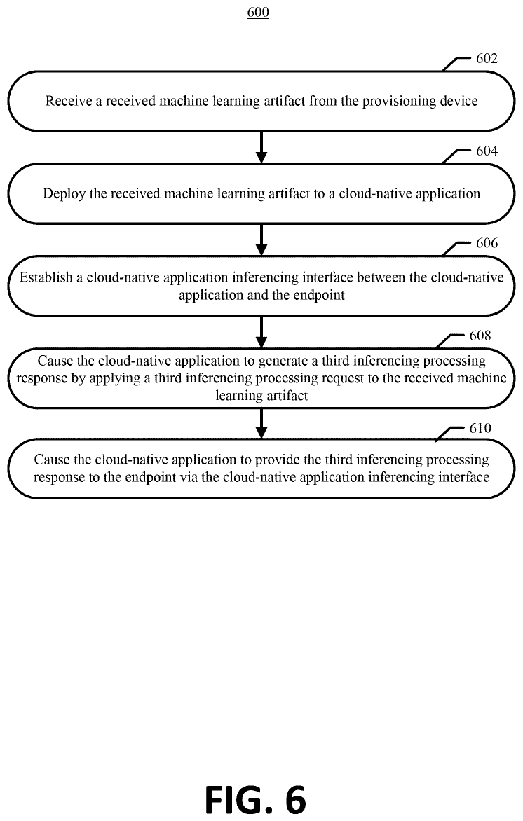

Referring now to FIG. 6, a flowchart providing an example method 600 is illustrated. In this regard, FIG. 6 illustrates operations that may be performed by the provisioning device 110, the model deployment system 140, the endpoint 180, a device associated with the cloud-native application 150, a device associated with the container-based application 160, and/or a device associated with the edge-based application 170, the artifact repository 120, the one or more image repositories 130, and/or the like. In some embodiments, the method 600 includes operations for at least causing the cloud-native application to provide the third inferencing processing response to the endpoint 180 via the cloud-native application inferencing interface. In some embodiments, the example method 600 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 may include receiving a received machine learning artifact from the provisioning device. As described above, in some embodiments, the model deployment system may be configured to receive a received machine learning artifact. In some embodiments, the model deployment system is configured to receive a machine learning artifact from the provisioning device and/or one or more other computing devices external to the model deployment system. In this regard, for example, the provisioning device and/or one or more other computing devices external to the model deployment system may be configured to generate a machine learning artifact and provide the machine learning artifact to the model deployment system.

As shown in block 604, the method 600 may include deploying the received machine learning artifact to a cloud-native application. As described above, in some embodiments, As described above, in some embodiments, the model deployment system is configured to deploy a machine learning artifact that the model deployment system generated. For example, the model deployment system may be configured to deploy a generated machine learning artifact that was generated by the model deployment system to the cloud-native application. In some embodiments, the model deployment system is configured to deploy a machine learning artifact that the model deployment system received. For example, the model deployment system may be configured to deploy a received machine learning artifact that was received by the model deployment system to the cloud-native application.

In some embodiments, deploying a machine learning artifact to an application of the plurality of applications enables the application to operate, execute, run, and/or host the machine learning artifact. In this regard, for example, deploying a machine learning artifact to an application of the plurality of applications enables the application to operate, execute, run, and/or host the machine learning artifact such that the machine learning artifact can be used to generate inferencing processing responses based on inferencing processing requests.

As shown in block 606, the method 600 may include establishing a cloud-native application inferencing interface between the cloud-native application and the endpoint. As described above, in some embodiments, an inferencing interface is a gateway, communication channel, application programming interface (API), and/or the like that enables data to be transmitted between the endpoint and one or more of the plurality of applications. For example, an inferencing interface is a gateway, communication channel, application programming interface (API), and/or the like that enables inferencing processing requests and/or inferencing processing responses to be transmitted between the endpoint and one or more of the plurality of applications. In this regard, in some embodiments, the model deployment system is configured to establish a cloud-native application inferencing interface between the cloud-native application and the endpoint such that inferencing processing requests and/or inferencing processing responses can be transmitted between the endpoint and the cloud-native application. In some embodiments, the model deployment system is configured to establish a container-based application inferencing interface between the container-based application and the endpoint such that inferencing processing requests and/or inferencing processing responses can be transmitted between the endpoint and the container-based application. In some embodiments, the model deployment system is configured to establish an edge-based application inferencing interface between the edge-based application and the endpoint such that inferencing processing requests and/or inferencing processing responses can be transmitted between the endpoint and the edge-based application. In some embodiments, a container-based application inferencing interface and/or an edge-based application inferencing interface correspond to a first inferencing interface.

As shown in block 608, the method 600 may include causing the cloud-native application to generate a third inferencing processing response by applying a third inferencing processing request to the received machine learning artifact. As described above, in some embodiments, an inferencing processing request is a data object that is representative and/or indicative of an input to a machine learning artifact and/or a machine learning image. For example, an inferencing processing request may be a data object that is representative and/or indicative of an unprocessed image. In this regard, in some embodiments, an unprocessed image is an image that has not been processed using a machine learning artifact and/or a machine learning image (e.g., a photo or drawing that has not been processed using a machine learning artifact and/or a machine learning image).

As shown in block 610, the method 600 may include causing the cloud-native application to provide the third inferencing processing response to the endpoint via the cloud-native application inferencing interface. As described above, in some embodiments, an inferencing processing response is a data object that is representative and/or indicative of an output of a machine learning artifact and/or a machine learning image. For example, an inferencing processing response may be a data object that is representative and/or indicative of a processed image. In this regard, in some embodiments, a processed image is an image that has been processed using a machine learning artifact and/or a machine learning image (e.g., a photo or drawing that has been processed using a machine learning artifact and/or a machine learning image). For example, an image may be processed in a machine learning artifact and/or a machine learning image to adjust the image's exposure, white balance, colors, and/or the like.

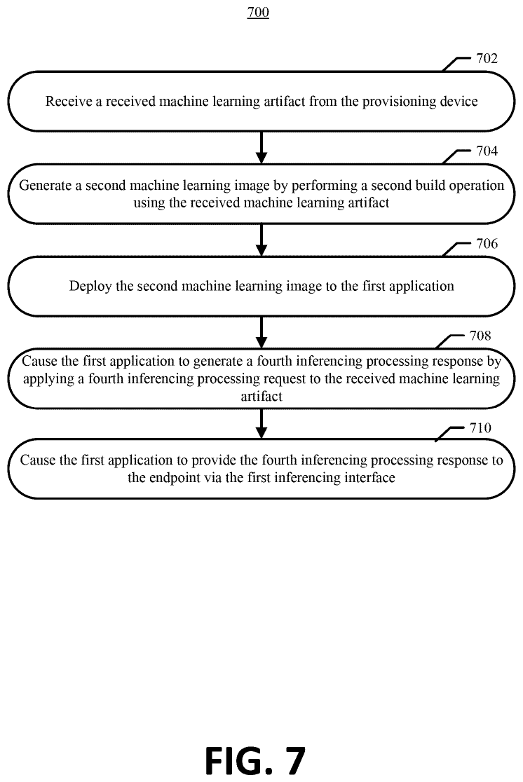

Referring now to FIG. 7, a flowchart providing an example method 700 is illustrated. In this regard, FIG. 7 illustrates operations that may be performed by the provisioning device 110, the model deployment system 140, the endpoint 180, a device associated with the cloud-native application 150, a device associated with the container-based application 160, and/or a device associated with the edge-based application 170, the artifact repository 120, the one or more image repositories 130, and/or the like. In some embodiments, the method 700 includes operations for at least causing the first application to provide the fourth inferencing processing response to the endpoint 180 via the first inferencing interface. In some embodiments, the example method 700 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 may include receiving a received machine learning artifact from the provisioning device. As described above, in some embodiments, the model deployment system may be configured to receive a received machine learning artifact. In some embodiments, the model deployment system is configured to receive a machine learning artifact from the provisioning device and/or one or more other computing devices external to the model deployment system. In this regard, for example, the provisioning device and/or one or more other computing devices external to the model deployment system may be configured to generate a machine learning artifact and provide the machine learning artifact to the model deployment system.

As shown in block 704, the method 700 may include generating a second machine learning image by performing a second build operation using the received machine learning artifact. As described above, in some embodiments, a machine learning image is a data object or data entity that is generated by a build operation (e.g., a machine learning related build operation). In this regard, in some embodiments, a machine learning image may be a trained machine learning model. Additionally, or alternatively, a machine learning image may be a partially trained machine learning model. Additionally, or alternatively, a machine learning image may be data generated during a build operation. In some embodiments, a machine learning image is associated with the container-based application and/or the edge-based application. In this regard, for example, a machine learning image may be configured such that it can be operated, executed, and/or run by the container-based application and/or the edge-based application.

As shown in block 706, the method 700 may include deploying the second machine earning image to the first application. As described above, in some embodiments, the model deployment system is configured to deploy a machine learning image that the model deployment system generated. For example, the model deployment system may be configured to deploy a first machine learning image that was generated by the model deployment system to the container-based application and/or the edge-based application. As another example, the model deployment system may be configured to deploy a second machine learning image that was generated by the model deployment system to the container-based application and/or the edge-based application.

In some embodiments, deploying a machine learning image to an application of the plurality of applications enables the application to operate, execute, run, and/or host the machine learning image. In this regard, for example, deploying a machine learning image to an application of the plurality of applications enables the application to operate, execute, run, and/or host the machine learning image such that the machine learning image can be used to generate inferencing processing responses based on inferencing processing requests.

As shown in block 708, the method 700 may include causing the first application to generate a fourth inferencing processing response by applying a fourth inferencing processing request to the received machine learning artifact. As described above, in some embodiments, an inferencing processing request is a data object that is representative and/or indicative of an input to a machine learning artifact and/or a machine learning image. For example, an inferencing processing request may be a data object that is representative and/or indicative of an unprocessed image. In this regard, in some embodiments, an unprocessed image is an image that has not been processed using a machine learning artifact and/or a machine learning image (e.g., a photo or drawing that has not been processed using a machine learning artifact and/or a machine learning image).

As shown in block 710, the method 700 may include causing the first application to provide the fourth inferencing processing response to the endpoint via the first inferencing interface. As described above, in some embodiments, inferencing processing response is a data object that is representative and/or indicative of an output of a machine learning artifact and/or a machine learning image. For example, an inferencing processing response may be a data object that is representative and/or indicative of a processed image. In this regard, in some embodiments, a processed image is an image that has been processed using a machine learning artifact and/or a machine learning image (e.g., a photo or drawing that has been processed using a machine learning artifact and/or a machine learning image). For example, an image may be processed in a machine learning artifact and/or a machine learning image to adjust the image's exposure, white balance, colors, and/or the like.

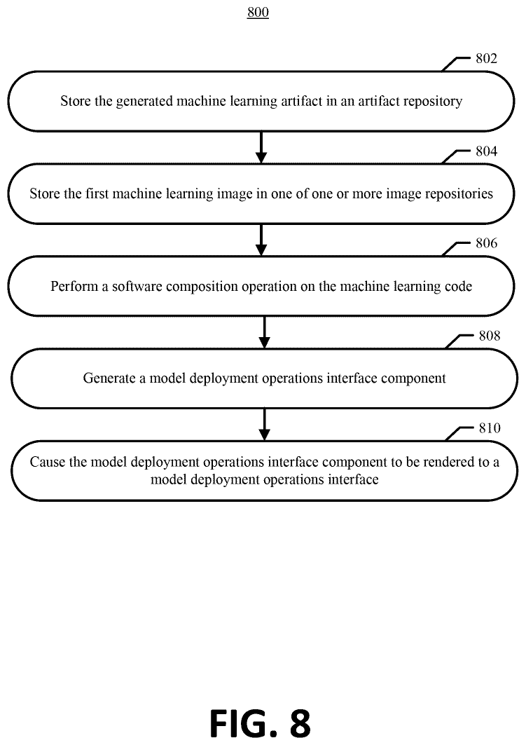

Referring now to FIG. 8, a flowchart providing an example method 800 is illustrated. In this regard, FIG. 8 illustrates operations that may be performed by the provisioning device 110, the model deployment system 140, the endpoint 180, a device associated with the cloud-native application 150, a device associated with the container-based application 160, and/or a device associated with the edge-based application 170, the artifact repository 120, the one or more image repositories 130, and/or the like. In some embodiments, the method 800 includes operations for at least performing a software composition operation. In some embodiments, the example method 800 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 400 may include storing the generated machine learning artifact in an artifact repository. As described above, in some embodiments, the model deployment system may be configured to store a machine learning artifact in the artifact repository after receiving the machine learning artifact. As another example, the model deployment system may be configured to store a machine learning artifact in the artifact repository after generating the machine learning artifact. In some embodiments, the model deployment system is configured to store a machine learning artifact in the artifact repository such that the machine learning artifact is associated with its machine learning artifact identifier. In this regard, for example, a machine learning artifact may be searchable in the artifact repository using the machine learning artifact's corresponding machine learning artifact identifier.

As shown in block 804, the method 800 may include storing the first machine learning image in one of one or more image repositories. As described above, in some embodiments, the model deployment system may be configured to store a machine learning image in the one or more image repositories after receiving the machine learning image. As another example, the model deployment system may be configured to store a machine learning image in the one or more image repositories after generating the machine learning image. In some embodiments, the model deployment system is configured to store a machine learning image in the one or more image repositories such that the machine learning image is associated with its machine learning image identifier. In this regard, for example, a machine learning image may be searchable in the one or more image repositories using the machine learning image's corresponding machine learning image identifier.

As shown in block 806, the method 800 may include performing a software composition operation on the machine learning code. As described above, in some embodiments, the model deployment system may be configured to perform a software composition operation on machine learning code after receiving the machine learning code and before using the machine learning code to generate a machine learning artifact.

In some embodiments, a software composition operation includes the model deployment system being configured to scan and/or analyze machine learning code to identify one or more security risks associated with the machine learning code. For example, the one or more security risks associated with machine learning code may include malware, such as malware configured to compromise the model deployment system and/one or more of the cloud-native application, the container-based application, the edge-based application. In some embodiments, a software composition operation includes the model deployment system being configured to scan and/or analyze machine learning code to identify one or more open-source risks associated with the machine learning code. For example, the one or more open-source risks associated with machine learning code may include portions of the machine learning code associated with copyleft licenses and/or other non-permissive licenses.

As shown in block 808, the method 800 may include generating a model deployment operations interface component. As described above, in some embodiments, the model deployment operations interface component includes a model deployment display element. In some embodiments, the model deployment display element is configured to display where machine learning artifacts are deployed. For example, the model deployment display element may be configured to display that a generated machine learning artifact is deployed to the cloud-native application. As another example, the model deployment display element may be configured to display that a received machine learning artifact is deployed to the cloud-native application. In some embodiments, the model deployment display element is configured to display where machine learning images are deployed. For example, the model deployment display element may be configured to display that a first machine learning image is deployed to the container-based application and/or the edge-based application. As another example, the model deployment display element may be configured to display that a second machine learning image is deployed to the container-based application and/or the edge-based application.

In some embodiments, the model deployment operations interface component includes a software composition display element. In some embodiments, the software composition display element is configured to display a result associated with a software composition operation. For example, the software composition display element may be configured to display a result associated with a software composition operation that indicates that machine learning code includes malware. As another example, the software composition display element is configured to display a result associated with a software composition operation that indicates that machine learning code includes one or more open-source risks (e.g., a portion of the machine learning code is associated with a copyleft license).

As shown in block 810, the method 800 may include causing the model deployment operations interface component to be rendered to a model deployment operations interface. As described above, in some embodiments, the model deployment operations interface is provided at the provisioning device, the model deployment system, the endpoint, a device associated with the cloud-native application, a device associated with the container-based application, and/or a device associated with the edge-based application.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
receiving machine learning code from a provisioning device;
generating a generated machine learning artifact by performing a machine learning training operation using the machine learning code;
generating a first machine learning image by performing a first build operation using the generated machine learning artifact;
deploying the first machine learning image to a first application;
establishing a first inferencing interface of between the first application and an endpoint;
causing the first application to generate a first inferencing processing response by applying a first inferencing processing request to the first machine learning image; and
causing the first application to provide the first inferencing processing response to the endpoint via the first inferencing interface.

2. The method of claim 1, further comprising:
deploying the generated machine learning artifact to a cloud-native application; and
establishing a cloud-native application inferencing interface between the cloud-native application and the endpoint.

3. The method of claim 2, further comprising:
causing the cloud-native application to generate a second inferencing processing response by applying a second inferencing processing request to the generated machine learning artifact; and
causing the cloud-native application to provide the second inferencing processing response to the endpoint via the cloud-native application inferencing interface.

4. The method of claim 1, further comprising:
receiving a received machine learning artifact from the provisioning device;
deploying the received machine learning artifact to a cloud-native application; and
establishing a cloud-native application inferencing interface between the cloud-native application and the endpoint.

5. The method of claim 4, further comprising:
causing the cloud-native application to generate a third inferencing processing response by applying a third inferencing processing request to the received machine learning artifact; and
causing the cloud-native application to provide the third inferencing processing response to the endpoint via the cloud-native application inferencing interface.

6. The method of claim 1, further comprising:
receiving a received machine learning artifact from the provisioning device;
generating a second machine learning image by performing a second build operation using the received machine learning artifact; and
deploying the second machine learning image to the first application.

7. The method of claim 6, further comprising:
causing the first application to generate a fourth inferencing processing response by applying a fourth inferencing processing request to the received machine learning artifact; and
causing the first application to provide the fourth inferencing processing response to the endpoint via the first inferencing interface.

8. The method of claim 7, wherein the first application comprises a container-based application or an edge-based application.

9. The method of claim 7, wherein the first inferencing interface comprises a container-based application inferencing interface or an edge-based application inferencing interface.

10. The method of claim 1, further comprising:
storing the generated machine learning artifact in an artifact repository.

11. The method of claim 1, further comprising:
storing the first machine learning image in one of one or more image repositories.

12. The method of claim 1, further comprising:
performing a software composition operation on the machine learning code.

13. The method of claim 1, wherein the first inferencing processing request comprises an unprocessed image and the first inferencing processing response comprises a processed image.

14. The method of claim 1, further comprising:
generating a model deployment operations interface component, wherein the model deployment operations interface component comprises a model deployment display element and a software composition display element; and
causing the model deployment operations interface component to be rendered to a model deployment operations interface.

15. An apparatus comprising memory and one or more processors communicatively coupled to the memory, the one or more processors configured to:
receive machine learning code from a provisioning device;
generate a generated machine learning artifact by performing a machine learning training operation using the machine learning code;
generate a first machine learning image by performing a first build operation using the generated machine learning artifact;
deploy the first machine learning image to a first application;
establish a first inferencing interface of between the first application and an endpoint;
cause the first application to generate a first inferencing processing response by applying a first inferencing processing request to the first machine learning image; and
cause the first application to provide the first inferencing processing response to the endpoint via the first inferencing interface.

16. The apparatus of claim 15, wherein the one or more processors are further configured to:
receive a received machine learning artifact from the provisioning device;
deploy the received machine learning artifact to a cloud-native application; and
establish a cloud-native application inferencing interface between the cloud-native application and the endpoint.

17. The apparatus of claim 16, wherein the one or more processors are further configured to:
cause the cloud-native application to generate a third inferencing processing response by applying a third inferencing processing request to the received machine learning artifact; and
cause the cloud-native application to provide the third inferencing processing response to the endpoint via the cloud-native application inferencing interface.

18. The apparatus of claim 15, wherein the one or more processors are further configured to:
receive a received machine learning artifact from the provisioning device;
generate a second machine learning image by performing a second build operation using the received machine learning artifact; and
deploy the second machine learning image to the first application.

19. The apparatus of claim 18, wherein the first application comprises a container-based application or an edge-based application.

20. A computer program product comprising at least one non-transitory computer-readable storage medium having computer program code stored thereon that, in execution with at least one processor, configures the computer program product for:
receiving machine learning code from a provisioning device;
generating a generated machine learning artifact by performing a machine learning training operation using the machine learning code;
generating a first machine learning image by performing a first build operation using the generated machine learning artifact;
deploying the first machine learning image to a first application;
establishing a first inferencing interface of between the first application and an endpoint;
causing the first application to generate a first inferencing processing response by applying a first inferencing processing request to the first machine learning image; and
causing the first application to provide the first inferencing processing response to the endpoint via the first inferencing interface.
